(19) United States
(12) Patent Application Publication
(10) Pub. No.: US 2007/0144669 A1
(43) Pub. Date: Jun. 28, 2007

(54) Method of producing flexible laminate sheet

(75) Inventors: Takashi Kikuchi, Shiga (JP); Hiroyuki Tsuji, Shiga (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KANEKA CORPORATION, Osaka (JP)

(21) Appl. No.: 10/582,884

(22) PCT Filed: Dec. 20, 2004
(86) PCT No.: PCT/JP04/19490

§ 371 Date: Jun. 14, 2006

(30) Foreign Application Priority Data
Dec. 26, 2003 (JP) 2003-433973

(51) Int. Cl. C09J 5/00; B32B 37/10; B32B 37/20; B32B 37/26

(52) U.S. Cl. 156/311; 156/324; 156/323; 156/306.6; 156/308.2

(57) ABSTRACT

A method for producing a heat-resistant flexible laminate in which appearance defects, such as wrinkles and waviness, can be prevented and dimensional stability can be improved is provided. A method for producing a flexible laminate including a heat-resistant adhesive film (A) and a metal foil (B) bonded to at least one surface of the heat-resistant adhesive film (A) includes a step of performing thermal lamination by passing the heat-resistant adhesive film (A) and the metal foil (B) between at least one pair of metal rollers through a protective film; a step of slowly cooling a laminate including the heat-resistant adhesive film (A), the metal foil (B), and the protective film; and a step of separating the protective film. The slow cooling step is preferably performed by providing a heating mechanism, in particular, a slow-cooling roller, of which temperature is set lower than the surface temperature of the metal rollers. The surface temperature of the slow-cooling roller is preferably set lower than the surface temperature of the metal rollers by 50° C. to 250° C.

### TECHNICAL FIELD

The present invention relates to methods for producing flexible laminates. More particularly, the invention relates to a method for producing a heat-resistant flexible laminate in which appearance defects can be prevented and dimensional stability can be improved.

### BACKGROUND ART

Flexible laminates, which are produced by bonding metal foils, such as copper foils, onto at least one surface of heat-resistant films, such as polyimide films, have been commonly used as printed circuit boards for electronic and electrical devices, for example, cellular phones. In the manufacturing process of electronic and electrical devices, since flexible laminates are exposed to high temperatures during solder reflow, etc., the flexible laminates are required to have satisfactory heat resistance and high temperature dimensional stability.

In the past, flexible laminates have been generally produced by bonding heat-resistant films and metal foils using thermosetting adhesives, such as thermosetting resins. However, attention has recently been directed to flexible laminates produced by thermal lamination of heat-resistant films and metal foils using polyimide adhesives in order to further improve heat resistance and durability.

The flexible laminates produced by thermal lamination using polyimide adhesives have higher heat resistance compared with those produced using thermosetting adhesives. Furthermore, when flexible laminates are used in hinges of folding members of foldable cellular phones, while flexible laminates using thermosetting adhesives withstand about 30,000 times of folding, flexible laminates using polyimide adhesives withstand about 100,000 times of folding. Thus, the flexible laminates using polyimide adhesives have higher durability.

As heat-resistant adhesive films, polyimide films provided with adhesive layers having a glass transition temperature (Tg) of 200° C. or more are commonly used. Consequently, in order to thermally laminate the heat-resistant adhesive films with metal foils, thermal lamination must be performed at temperatures higher than Tg of the adhesive layers of the heat-resistant adhesive films, for example, at 300° C. or more.

Generally, in a thermal laminator, in order to reduce nonuniformity in pressure during thermal lamination, at least one of the rollers used for thermal lamination is a rubber roller. However, it is extremely difficult to perform thermal lamination at high temperatures of 300° C. or more using rubber rollers.

FIG. 4 is a schematic cross-sectional view showing an example of a conventional double belt press. In one method for bonding a heat-resistant adhesive film 13 and a metal foil 12, the double belt press shown in FIG. 4 is used. In this method, protective films 11, metal foils 12, and a heat-resistant adhesive film 13 are subjected to thermal lamination in a heating unit 8 using metal belts 14, and the resulting laminate is cooled in a cooling unit 9. Subsequently, the protective films 11 are removed to produce a flexible laminate 15. Such a method is disclosed in Japanese Unexamined Patent Application Publication No. 2001-129919. However, Japanese Unexamined Patent Application Publication No. 2001-129919 does not disclose at all a slow cooling step, which is important in the present invention, for heat-resistant adhesive films.

On the other hand, when a thermal laminator equipped with a pair of metal rollers is used, maintenance is less complex and cost of equipment is lower compared to the use of double belt presses. However, when thermal lamination is performed using a pair of metal rollers, unlike the use of rubber rollers, it is difficult to maintain uniformity of pressure during thermal lamination. Moreover, since the temperature rapidly increases during thermal lamination, wrinkles occur in the appearance of the resulting flexible laminate, thereby degrading the appearance of the flexible laminate.

FIG. 5 is a schematic cross-sectional view showing an example of a conventional thermal laminator. As shown in FIG. 5, by performing thermal lamination with a protective film 11 composed of polyimide or the like being disposed between each metal roller 4 and each metal foil 12, it is possible to reduce wrinkles occurring in the appearance of a flexible laminate 15 (e.g., Japanese Unexamined Patent Application Publication No. 2001-129918). In this method, by using the protective films 11 as cushioning materials, it is possible to maintain the uniformity in pressure applied by the metal rollers 4 during the thermal lamination. Furthermore, other advantages of interposing the protective films 11 are that the surfaces of the metal rollers 4 can be protected and that since the laminate is immobilized with the protective films, rapid expansion of materials due to heating can be suppressed and wrinkles are prevented from occurring. After the protective films 11 are subjected to thermal lamination together with the heat-resistant adhesive film 13 and the metal foils 12, the protective films 11 are removed from the flexible laminate 15 comprising the heat-resistant adhesive film 13 and the metal foils 12.

In the method disclosed in Japanese Unexamined Patent Application Publication No. 2001-129918, uniform pressure is applied during the thermal lamination, and it is thereby possible to reduce wrinkles occurring during the thermal lamination. However, in the method disclosed in Japanese Unexamined Patent Application Publication No. 2001-129918, conditions in the cooling step after the thermal lamination are not taken into consideration. Although the appearance of flexible laminates is improved by the method disclosed in Japanese Unexamined Patent Application Publication No. 2001-129918, improvement in the appearance under more strict conditions of evaluation is awaited. Furthermore, flexible laminates with improved dimensional characteristics are expected.

### DISCLOSURE OF INVENTION

The present invention solves the problems described above, and it is an object of the present invention to provide a method for producing a heat-resistant flexible laminate in which appearance defects, such as wrinkles and waviness, can be prevented and dimensional stability can be improved.

The present invention relates to a method for producing a flexible laminate including a heat-resistant adhesive film (A) and a metal foil (B) bonded to at least one surface of the heat-resistant adhesive film (A). The method includes a step of performing thermal lamination by passing the heat-resistant adhesive film (A) and the metal foil (B) between at least one pair of metal rollers through a protective film; a step of slowly cooling a laminate including the heat-resistant adhesive film (A), the metal foil (B), and the protective film; and a step of separating the protective film.

Preferably, the slow cooling step is performed by providing a heating mechanism of which temperature is set lower than the surface temperature of the metal rollers. More preferably, the heating mechanism includes a slow-cooling roller.

In the present invention, the term “slow-cooling roller” refers to a roller in which the roller surface temperature is set lower than that of the metal rollers for carrying out the thermal lamination and with which the laminate that has been thermally laminated is brought into contact in order to prevent the laminate from being rapidly cooled.

In the present invention, when a slow-cooling roller is used, preferably, the surface temperature of the slow-cooling roller is set lower than the surface temperature of the metal rollers by 50° C. to 250° C. Particularly preferably, the surface temperature of the slow-cooling roller is set in a range of 150° C. to 350° C.

In the slow cooling step, preferably, the cooling rate for the laminate is set in a range of 50° C./min to 300° C./min.

The present invention further relates to a method for producing a flexible laminate including a heat-resistant adhesive film (A) comprising one layer or two or more layers, one surface or both surfaces of the heat-resistant adhesive film (A) being composed of a thermally fusible resin, and a metal foil (B) bonded to at least one surface of the heat-resistant adhesive film (A). The method includes a step of performing thermal lamination by passing the heat-resistant adhesive film (A) and the metal foil (B) between at least one pair of metal rollers through a protective film; a step of slowly cooling a laminate including the heat-resistant adhesive film (A), the metal foil (B), and the protective film at a cooling rate of 300° C./min or less until the surface temperature of the laminate is decreased to a temperature equal to or less than the glass transition temperature of the thermally fusible resin; and a step of separating the protective film.

In such a case, preferably, at least one slow-cooling roller of which temperature is set at the glass transition temperature of the thermally fusible resin is provided. Furthermore, preferably, the slow cooling step is performed by providing a plurality of heating mechanisms including a slow-cooling roller.

In accordance with the present invention, it is possible to provide a heat resistant-flexible laminate in which appearance defects, such as wrinkles and waviness, are reduced by slowly cooling the flexible laminate that has been thermally laminated and which has high dimensional stability.

### BRIEF DESCRIPTION OF THE DRAWINGS

FIG. 1 is a schematic cross-sectional view showing a preferred example of a thermal laminator used in the present invention. FIG. 2 is a schematic, enlarged cross-sectional view of a laminate used in the present invention. FIG. 3 is a schematic, enlarged cross-sectional, view of a flexible laminate produced in accordance with the present invention. FIG. 4 is a schematic cross-sectional view showing an example of a conventional double belt press. FIG. 5 is a schematic cross-sectional view showing an example of a conventional thermal laminator.

### REFERENCE NUMERALS

1 and 11 protective film

2 and 12 metal foil

3 and 13 heat-resistant adhesive film

4 metal roller

5 and 15 flexible laminate

6 slow-cooling roller

7 laminate

8 heating unit

9 cooling unit

14 metal belt

### BEST MODE FOR CARRYING OUT THE INVENTION

The present invention is characterized in that a laminate when has been thermally laminated using at least one pair of metal rollers is slowly cooled. The present inventors have found that when a flexible laminate which has been thermally laminated at high temperatures is naturally cooled in the line without controlling temperature, the cooling rate differs depending on the part of the flexible laminate, and as a result, nonuniformity in temperature may occur in the flexible laminate, and protective films may be partially removed from the flexible laminate by strain of shrinkage due to cooling. In particular, when continuous production is performed, since take-up tension is constantly applied to the flexible laminate, the nonuniformity in temperature produces parts which are easily affected by the tension and parts which are less easily affected by the tension. Furthermore, if the flexible laminate is removed from the protective films before being fully cooled, rapid shrinkage due to cooling occurs because the flexible laminate is not immobilized by the protective films. These may result in appearance irregularities, such as wrinkles and waviness, in the resulting flexible laminate. Consequently, by providing the slow cooling step, nonuniformity in temperature due to rapid cooling of the laminate and removal of the protective films are prevented, and it is possible to prevent appearance defects, such as wrinkles and waviness, and degradation in dimensional characteristics. In the present invention, the slow cooling step refers to a step positively provided between the step of thermally laminating the protective films, the metal foil, and the heat-resistant adhesive film using at least one pair of metal rollers and the step of separating the protective films in order to prevent a rapid decrease in temperature.

As the means for slow cooling, preferably, a heating mechanism which is set at a temperature that is lower than the surface temperature of the metal rollers is provided. Preferably, in particular, the heating mechanism includes a slow-cooling roller. By using the slow-cooling roller, uniformity in the cooling rate, particularly, in the width direction of the laminate, is more satisfactorily ensured. The present invention will be described below with reference to the drawings.

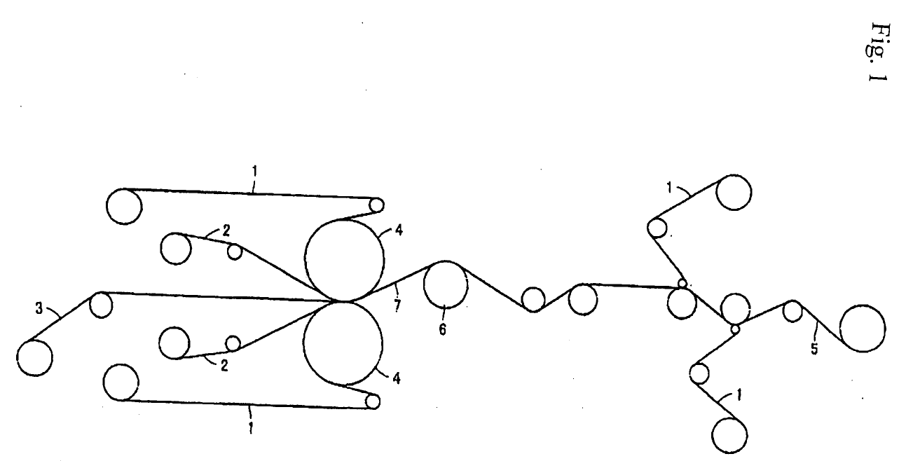

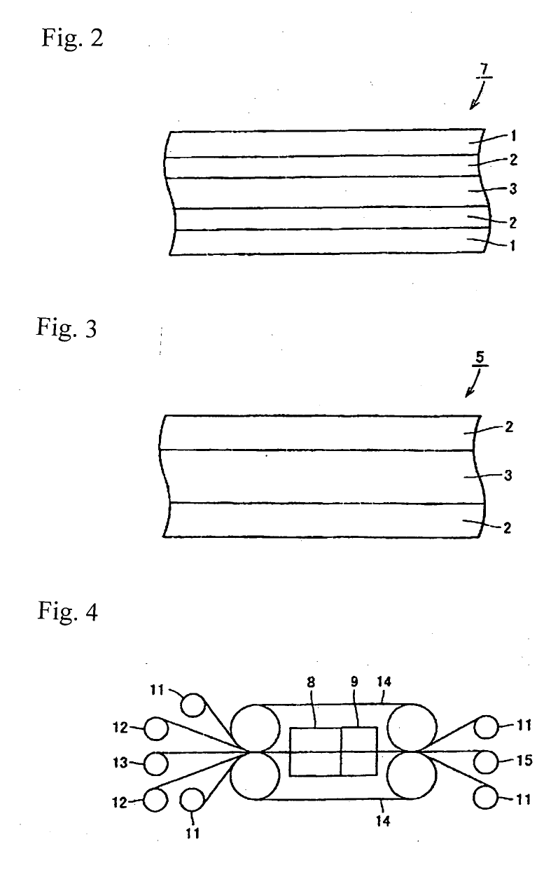

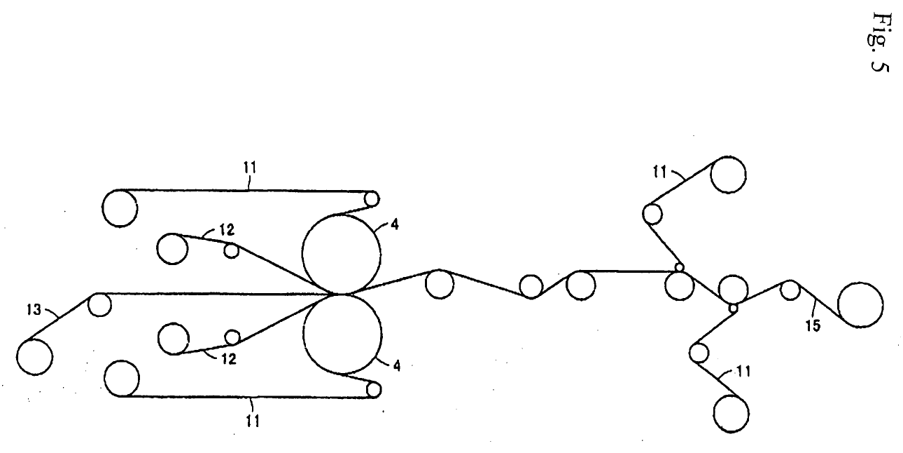

FIG. 1 is a schematic cross-sectional view showing a preferred example of a thermal laminator used in the present invention. FIG. 2 is a schematic, enlarged cross-sectional view of a laminate used in the present invention. FIG. 3 is a schematic, enlarged cross-sectional view of a flexible laminate produced in accordance with the present invention. A thermal laminator shown in FIG. 1 includes a pair of metal rollers 4 for thermally laminating metal foils 2 and a heat-resistant adhesive film 3 with a protective film 1 between each metal roller 4 and each metal foil 2, and a slow-cooling roller 6.

In the thermal laminator, the protective films 1, the metal foils 2, and the heat-resistant adhesive film 3 are thermally laminated by means of one pair of metal rollers 4. After the thermal lamination, a laminate 7 shown in the enlarged cross-sectional view of FIG. 2 is produced, the laminate 7 including the protective films 1, the metal foils 2, and the heat-resistant adhesive film 3 being bonded to each other. The laminate 7 is transferred preferably by a plurality of rollers while being slowly cooled. By removing the protective films 1 from the laminate 7, a flexible laminate 5 shown in the enlarged cross-sectional view of FIG. 3 is produced.

Preferred examples of the heat-resistant adhesive film to be used include a single-layer film composed of a thermally fusible resin, and a multi-layer film including a core layer which does not have a heat-sealing property and a thermally fusible resin layer provided on one surface or both surfaces of the core layer.

As the protective film, a film which withstands the thermal lamination temperature, which can form a laminate together with the flexible laminate with weak adhesion during the thermal lamination, and which can be easily removed from the flexible laminate in the separation step is preferably used. In particular, in view of excellent balance between heat resistance, durability, etc., a protective film composed of a non-thermoplastic polyimide is preferably used. Furthermore, in order to achieve a sufficient cushioning effect during the thermal lamination, preferably, the protective film has a thickness of 75 μm or more.

In the present invention, at least one pair of metal rollers heats the heat-resistant adhesive film, the metal foils, and the protective films while applying pressure, and thermally laminates the heat-resistant adhesive film and the metal foils with the protective film between each metal roller and each metal foil. At this stage, in order to prevent wrinkles, waviness, curling, etc., from occurring in the flexible laminate, uniformity in pressure and temperature in the width direction of the metal rollers is required. For example, when the metal roller itself has nonuniformity in temperature, because of a difference in the coefficient of expansion of the metal roller, a difference in the roller diameter between the center and the edges, i.e., a temperature crown, occurs. Consequently, the metal roller deforms, which may result in nonuniformity in the pressure applied to the flexible laminate. If the difference in temperature between the center and the edges of the metal roller is set at 10° C. or less, desired uniformity in pressure and temperature is ensured.

The surface temperature of the metal roller is preferably higher than the glass transition temperature of the thermally fusible resin in the heat-resistant adhesive film by more than 50° C. In order to increase the thermal lamination rate, the surface temperature of the metal roller is more preferably higher than the glass transition temperature of the thermally fusible resin by more than 100° C. Examples of the heating method for the metal roller include a heat medium circulation method, a hot-air heating method, and a dielectric heating method.

The laminate including the heat-resistant adhesive film, the metal foils, and the protective films is thermally laminated by means of the metal rollers and then slowly cooled with a slow-cooling roller. The surface temperature of the slow-cooling roller is set lower than the surface temperature of the metal roller. The difference in the surface temperature between the metal roller and the slow-cooling roller is preferably in a range of 50° C. to 250° C., and particularly preferably in a range of 50° C. to 150° C. If the difference in the surface temperature between the slow-cooling roller and the metal roller is 50° C. or more, the flexible laminate which has been passed between the metal rollers for thermal lamination can be cooled to a sufficiently low temperature by the time it reaches separation means for the protective films. Therefore, it is possible to prevent appearance defects during the removal. If the difference in the surface temperature between the slow-cooling roller and the metal roller is 250° C. or less, there is no risk that the flexible laminate will be rapidly cooled, and thereby it is possible to effectively prevent wrinkles, waviness, curling, etc.

The surface temperature of the slow-cooling roller is set preferably in a range of 150° C. to 350° C., and more preferably in a range of 200° C. to 300° C. If the surface temperature is 150° C. or more, rapid cooling of the laminate is prevented, and nonuniform shrinkage can be effectively prevented. If the surface temperature is 350° C. or less, since the slow-cooling roller is set at a temperature lower than the thermal lamination temperature, the purpose of the slow cooling step can be fulfilled. When a plurality of slow-cooling means is provided in the slow cooling step, the slow cooling temperature of each slow-cooling means (the surface temperature of each slow-cooling roller when slow-cooling rollers are used) is set preferably in a range of 150° C. to 350° C., and more preferably in a range of 200° C. to 300° C.

The cooling rate for the laminate in the slow cooling step is set preferably at 50° C./min to 300° C./min, and more preferably at 150° C./min to 250° C./min. If the cooling rate is 50° C./min or more, production efficiency is satisfactory. If the cooling rate is 300° C./min or less, there is no risk that the laminate will be rapidly cooled, and it is possible to prevent nonuniformity in temperature of the flexible laminate and appearance defects due to the removal of the protective films. When a plurality of slow-cooling means is provided in the slow cooling step, the cooling rate of each slow-cooling means is set preferably in a range of 50° C./min to 300° C./min, and more preferably in a range of 200° C. to 300° C. Additionally, the cooling rate can be calculated from the difference between the actual temperature of the laminate immediately after the thermal lamination and the actual temperature of the laminate after the slow cooling step and the time required for transferring the laminate between the two temperature measurement positions. When a plurality of slow-cooling means is provided in the slow cooling step, the cooling rate may be calculated, for example, from the difference between the actual temperature of the laminate after the first slow cooling step and the actual temperature of the laminate after the second slow cooling step, or the difference between the actual temperature of the laminate after the final slow cooling step and the actual temperature of the laminate immediately before the removal of the protective films and the time required for transferring the laminate between the two temperature measurement positions.

The maximum value of the cooling rate for the laminate from the thermal lamination temperature controlled by the surface temperature of the metal roller to the glass transition temperature of the thermally fusible resin is preferably set at 300° C./min or less.

By setting the maximum value of the cooling rate in the range described above, it is possible to control so that no part of the laminate is rapidly cooled in the slow cooling step, and thereby nonuniform shrinkage can be prevented.

In the slow cooling step of the present invention, in addition to the slow-cooling roller or in combination of the slow-cooling roller, one or two or more heating mechanisms may be used. Examples of the heating mechanism include far infrared heaters, near infrared heaters, and heating ovens. These heaters are preferably installed such that the maximum temperature of the laminate at the part heated with each of the heaters is lower than the surface temperature of the metal roller, for example, by 50° C. to 100° C. Furthermore, although the slow-cooling roller may be provided only in one stage, slow-cooling rollers are preferably provided in two or more stages. When slow-cooling rollers are provided in two or more stages, preferably, the surface temperatures of the slow-cooling rollers are set so as to decrease as the laminate passes over the line. However, if the difference in temperature between two adjacent slow-cooling rollers is too small, rollers are inevitably installed in multiple stages, and the line is lengthened more than necessary. Therefore, preferably, the difference in temperature between two adjacent slow-cooling rollers is set at 50° C. or more in view of production efficiency. In such a case, for example, when the thermal lamination temperature is set at 300° C. or more, by providing slow-cooling rollers in two to five stages, the laminate can be cooled to a desired temperature.

The slow-cooling rollers may be constructed as single rollers or as roller pairs.

The material for the surface of the slow-cooling roller is not particularly limited. For example, when the surface temperature of the slow-cooling roller is set at 200° C. or more, since it is difficult to use a common rubber roller, a metal roller is preferably used. As the preferred material, SUS (stainless steel), aluminum, or the like is used. Additionally, in order to improve wear resistance by improving the hardness of the surface of the roller, chromium plating may be preferably performed.

Furthermore, since the cooling rate for the laminate depends on the types and thicknesses of the heat-resistant adhesive film, the metal foils, and the protective films, the surface temperatures of the metal rollers, the surface temperatures of the slow-cooling rollers, the preset temperatures and locations of other heating mechanisms, the line speed, etc., the cooling rate may be set in a desired range by appropriately controlling these factors.

The protective films are separated from the laminate which has been slowly cooled by the method described above with separation means, such as removal means. When a heat-resistant adhesive film including a thermally fusible resin is used, the temperature of the laminate during the removal of protective films is preferably set lower than the Tg of the thermally fusible resin, more preferably set lower than the Tg by 50° C. or more, and still more preferably set lower than the Tg by 100° C. or more. Most preferably, the protective films are removed from the flexible laminate when the laminate is cooled to room temperature. If the protective films are removed at a temperature higher than the Tg of the thermally fusible resin, since the heat-resistant adhesive film easily deforms, wrinkles are likely to occur in the flexible laminate to cause appearance defects.

During the removal of the protective films, preferably, the adhesion strength between each of the protective films and the flexible laminate is, for example, set in a range of 0.1 to 3 N/cm. In such a case, there is no risk that the protective films are removed from the flexible laminate before the predetermined removal step, and removal defects during the removal are effectively prevented. Consequently, a flexible laminate without appearance defects can be produced.

In the present invention, particularly excellent effects are exhibited when the thermal lamination temperature is 300° C. or more, and preferably 350° C. or more.

The flexible laminate of the present invention is produced by the method described above. Furthermore, the removed protective films can be repeatedly used. A feeding device and a winding device for the flexible laminate are of course provided in the front and back of the metal rollers for thermal lamination. By also providing feeding devices and winding devices for the protective films, the protective films which have been subjected to thermal lamination are taken up with the winding devices and set again on the feeding side, and thus the protective films can be reused. When winding is performed, an edge position detector and a winding position adjuster may be installed so that the edges of the protective material can be precisely aligned before winding.

<Heat-Resistant Adhesive Film>

The heat-resistant adhesive film used in the present invention preferably has an insulating property so as to be suitable in the electronic and electrical device applications. In the present invention, “heat resistance” in the heat-resistant adhesive film means that the film has characteristics of being able to withstand high temperatures during the thermal lamination. Furthermore, in the heat-resistant adhesive film of the present invention, “adhesion” means that the film is bonded to the metal foil due to the thermal adhesiveness (heat-sealing property) at the surface of the film at high temperatures during thermal lamination, and it is not necessary that the surface of the film always has adhesiveness (tackiness) at room temperature as in tack seals.

As the heat-resistant adhesive film, a single-layer film composed of a thermally fusible resin, a multi-layer film including a core layer which does not have a heat-sealing property and a thermally fusible resin layer provided on one surface or both surfaces of the core layer, or the like may be used. As the thermally fusible resin, a resin containing a thermoplastic polyimide component is preferably used. Examples of such a resin include thermoplastic polyimides, thermoplastic polyamide-imides, thermoplastic polyetherimides, and thermoplastic polyesterimides. Among these, thermoplastic polyimides and thermoplastic polyesterimides are particularly preferably used. In order to improve adhesiveness, etc., in addition to the thermally fusible resins described above, thermosetting resins, such as epoxy resins and acrylic resins, etc., may be incorporated into the thermally fusible resin layer.

On the other hand, as the core layer which does not have a heat-sealing property, for example, a non-thermoplastic polyimide film, an aramid film, a polyetheretherketone film, a polyethersulfone film, a polyarylate film, or a polyethylene naphthalate film may be used. Here, the term “non-thermoplastic” does not mean “thermosetting” and examples of the non-thermoplastic film include a film in which glass transition or melting is not clearly observed because the decomposition temperature is lower than the glass transition temperature (Tg) or for other reasons. In the present invention, in view of electrical characteristics (insulating property), use of a non-thermoplastic polyimide film is particularly preferable. In such a case, the core layer is not easily softened or melted by heating during thermal lamination and has characteristics of retaining shape satisfactorily.

In the case of a multi-layer film including a core layer which does not have a heat-sealing property and a thermally fusible resin layer provided only on one surface of the core layer, in order to prevent warpage after lamination of a metal foil, a backing layer may be provided on a surface not provided with the thermally fusible resin layer.

The method for producing the heat-resistant adhesive film is not particularly limited, and any of various production methods may be employed. In order to produce a single-layer film composed of a thermally fusible resin, for example, a belt casting method or an extrusion method can be used.

In order to produce a multi-layer film including a core layer which does not have a heat-sealing property and a thermally fusible resin layer provided on one surface or both surfaces of the core layer, for example, a method in which a thermally fusible resin is applied to one surface or both surfaces of the core layer which does not have a heat-sealing property, the application being performed to one surface at a time or both surfaces simultaneously, or a method in which a single-layer film composed of only a thermally fusible resin is bonded to one surface or both surfaces of a film constituting the core layer can be used.

Furthermore, in the method for producing a multi-layer film including a core layer which does not have a heat-sealing property and thermally fusible resin layers provided on both surfaces of the core layer, in particular, when a thermoplastic polyimide is used as the thermally fusible resin, either a method in which a polyamic acid is applied to the core layer and then imidization is performed while drying or a method in which a soluble polyimide resin is directly applied to the core layer, and then drying is performed may be employed. In another possible method, a thermally fusible resin, a resin which does not have a heat-sealing property, and a thermally fusible resin are coextruded so as to form a structure of thermally fusible resin/resin which does not have a heat-sealing property/thermally fusible resin, and thereby a triple-layer heat-resistant adhesive film is produced in one step.

<Protective Film>

The protective film used in the present invention must withstand the thermal lamination temperature. The coefficient of linear expansion of the protective film is preferably 50 ppm/° C. or less. When the coefficient of linear expansion of the protective film is greater than 50 ppm/° C., larger dimensional changes occur in the protective film, compared with the flexible laminate, due to heating during the thermal lamination and cooling after the thermal lamination, which may result in wrinkles in the flexible laminate. Furthermore, the thickness of the protective film is preferably 75 μm or more, more preferably 100 μm or more, and still more preferably 125 μm or more. When the thickness of the protective film is less than 75 μm, the thickness of the protective film is so thin that the protective film cannot withstand the shrinkage of the flexible laminate due to cooling, and wrinkles tend to occur in the flexible laminate. As the thickness of the protective film increases to 100 μm or more or to 125 μm or more, the protective film becomes able to withstand the shrinkage of the flexible laminate due to cooling, and wrinkles occur less easily in the flexible laminate.

If the protective film can remain in light contact with the flexible laminate even after the thermal lamination by means of the metal rollers, it is not particularly necessary to perform surface treatment or the like on the protective film. On the other hand, when the protective film cannot remain in light contact with the flexible laminate, surface treatment may be performed on the protective film so as to enable light contact, similar treatment may be performed on the metal foil on the side of the flexible laminate, or surface treatment may be performed both on the protective film and on the metal foil on the side of the flexible laminate. Furthermore, surface treatment performed for other purposes, such as rustproofing treatment may also be acceptable if the treatment allows the protective film and the flexible laminate to be in light contact with each other.

When the protective film alone does not enable a state in which the protective film is in light contact with the flexible laminate, it is preferable to deposit a material that does not exhibit tackiness at normal temperature and that exhibits tackiness at the thermal lamination temperature on the entirety or at least a surface of the protective film. As the material that does not exhibit tackiness at normal temperature and that exhibits tackiness at the thermal lamination temperature, for example, a thermally fusible resin having a Tg in the vicinity of the thermal lamination temperature is conceivable. The lamination temperature during the production of the heat-resistant flexible laminate is usually high at 200° C. or more, and as the material that can withstand such a temperature, a heat-resistant thermoplastic resin, such as a thermoplastic polyimide resin, a thermoplastic polyamide resin, or a thermoplastic polyamide-imide resin, is preferable. A protective film having one surface provided with such a material that exhibits tackiness at the thermal lamination temperature is preferably used.

The method for depositing the material having tackiness on one surface of the protective film is not particularly limited as long as a predetermined resin structure is obtained. Examples of the method include a method in which the material having tackiness is applied to one surface of the protective film, and then drying is performed, a method in which a film composed of the material having tackiness is preliminarily formed, and then the film is bonded to the protective film, and a method in which a layer of the material having tackiness is formed simultaneously with the formation of the protective film.

The thickness of the layer of the material exhibiting tackiness is not particularly limited. However, if the thickness is excessively large, cohesive failure occurs in the material exhibiting tackiness when the protective film is removed from the metal foil, which may result in transferring to the metal foil. Consequently, the thickness is preferably 10 μm or less, and more preferably 5 μm or less.

<Metal Foil>

As the metal foil in the present invention, for example, a copper foil, a nickel foil, an aluminum foil, or a stainless steel foil is used. The metal foil may have a single-layer structure or a multi-layer structure including a rust preventive layer or a heat-resistant layer (e.g., a layer formed by plating chromium, zinc, nickel, or the like) provided on the surface of a metal foil. Examples of the type of copper foil include rolled copper foils, electrolytic copper foils, and HTE copper foils. As the thickness of the metal foil is decreased, the line width of the circuit patterns on printed circuit boards can be decreased, and therefore, the thickness of the metal foil is preferably 35 μm or less, and more preferably 18 μm or less.

In the present invention, in order to more effectively prevent appearance defects, the following steps may be included.

For example, prior to the thermal lamination, from the standpoints of avoiding a rapid increase in temperature and preventing expansion wrinkles in the protective film, the protective film, the metal foil, and the heat-resistant adhesive film may be subjected to preheating. The preheating step can be carried out, for example, by bringing the protective film, the metal foil, and the heat-resistant adhesive film into contact with heating rollers.

Here, more preferably, the temperature of the protective film is set in a range from a temperature 10° C. lower than the metal roller to the surface temperature of the metal roller. The contact time between the heating roller and the protective film is preferably 1 second or more, more preferably 10 seconds or more, and particularly preferably 15 seconds or more. The roller diameter is appropriately selected depending on the contact time. For example, the protective film can be heated by wrapping the protective film around a portion of the heating roller so as to cover a quarter circumference or more or a half circumference or more. Thereby, the protective film has a predetermined temperature immediately prior to the thermal lamination, and the protective film free from expansion wrinkles, the heat-resistant adhesive film, and the metal foil can be laminated. Thus, a flexible laminate without wrinkles can be produced.

Furthermore, prior to the thermal lamination, preferably, a step of removing foreign matter from the protective film, the metal foil, and the heat-resistant adhesive film is provided. Examples of the foreign matter include PET scraps and polyester fiber waste. In particular, in order to reuse the protective film repeatedly, it is important to remove foreign matter attached to the protective film. In the foreign matter removal step, for example, foreign matter is removed by a cleaning treatment using water, a solvent, or the like, or using a pressure-sensitive adhesive rubber roller. Above all, the method using the pressure-sensitive adhesive rubber roller is preferable because of simplicity in equipment. As the material for the pressure-sensitive adhesive rubber roller, butyl rubber, silicone rubber, or the like is preferable.

Furthermore, in order to prevent the entry of foreign matter from the environment into the protective film, the metal foil, and the heat-resistant adhesive film, means for removing electrostatic charges from the protective film, the metal foil, and the heat-resistant adhesive film is preferably provided prior to the thermal lamination. As the means for removing electrostatic charges, for example, a method using destaticizing air may be employed. It is also effective to keep the environment for producing the flexible laminate clean. Specifically, a method in which production is performed in a clean room, a method in which a thermal laminator is surrounded by a clean booth, a method in which a thermal laminator in a clean room is further surrounded by a clean booth, or the like may be used.

The pressure (linear pressure) of the metal rollers during the thermal lamination is preferably 49 N/cm to 490 N/cm, and more preferably 98 N/cm to 294 N/cm. When the linear pressure during the thermal lamination is less than 49 N/cm, the linear pressure is excessively small, and adhesion between the metal foil and the heat-resistant adhesive film tends to be decreased. When the linear pressure is greater than 490 N/cm, the linear pressure is excessively large, and strains are generated in the flexible laminate. As a result, when the flexible laminate is used as a product, the dimensional change of the flexible laminate after the removal of the metal foil may be increased. Examples of the method for pressurizing using the metal rollers include a hydraulic method, a pneumatic method, and a gap pressure method.

The thermal lamination rate is preferably 0.5 m/min or more, and more preferably 1 m/min or more. If the thermal lamination rate is 0.5 m/min or more, the productivity of the flexible laminate having improved appearance and dimensional stability after removal of the metal foils can be increased.

### EXAMPLES

### Examples 1 to 3

<Production of Flexible Laminate>

Flexible laminates were produced using a thermal laminator shown in FIG. 1. As a protective film 1, a non-thermoplastic polyimide film (“APICAL 125NPI” manufactured by Kaneka Corporation) with a thickness of 125 μm, as a metal foil 2, a copper foil with a thickness of 18 μm, and as a heat-resistant adhesive film 3, a heat-resistant adhesive film (“PIXEO HC-142” manufactured by Kaneka Corporation, glass transition temperature 240° C.) with a thickness of 25 μm were used.

While rolls of the protective film 1, rolls of the metal foil 2, and a roll of heat-resistant adhesive film 3 were each being rotated, electrostatic charges and foreign matter were removed. Subsequently, with the protective films 1 being preheated by wrapping the protective films around a pair of metal rollers 4 so as cover a half circumference, the metal foils 2, and the heat-resistant adhesive film 3 were thermally laminated at a temperature of 360° C., a line speed of 1.5 m/min, and a lamination pressure of 196 N/cm to produce a laminate 7 having a five-layer structure in which the metal foils and the protective films were bonded in that order to both surfaces the heat-resistant adhesive film.

Subsequently, the laminate 7 was slowly cooled by means of a slow-cooling roller 6 which was set so as to satisfy the temperature of the laminate shown in Table 1, and the protective films 1 were removed from the laminate 7 to produce a flexible laminate. The slow-cooling roller was installed right behind the metal rollers, specifically in a position at a horizontal distance of 1 m between the central axis of each metal roller and the central axis of the slow-cooling roller. The temperature of the slow-cooling roller was 250° C. The actual temperatures of the laminate at the thermal lamination portion, the portion of contact with the slow-cooling roller, and the removal portion were measured. The cooling rates of the laminate were calculated from the differences in temperature between the individual temperature measurement positions and the times required for transferring the laminate between the individual temperature measurement positions. The results are shown in Table 1. The adhesion strength between the protective film and the flexible laminate was 2 N/cm.

With respect to each of the resulting flexible laminates, appearance and dimensional stability (MD direction and TD direction) were evaluated by the methods which will be described below. The results are shown in Table 1.

TABLE 1

| | | | | | | Comparative |
|---|---|---|---|---|---|---|
| | | Example 1 | Example 2 | Example 3 | Example 4 | Example |
| Actual | Thermal lamination portion | 360 | 360 | 360 | 360 | 360 |
| temperature | Slow cooling portion | 250 | 200 | 150 | 280 | — |
| of laminate (° C.) | Midpoint between thermal | — | — | — | — | 40 |
| | lamination portion and removal | | | | | |
| | portion | | | | | |
| | Removal portion | 30 | 30 | 40 | 120 | 30 |
| Cooling rate | Thermal lamination portion - Slow | 110 | 160 | 210 | 80 | — |
| (° C./min) | cooling portion | | | | | |
| | Slow cooling portion - Removal | 150 | 120 | 80 | 100 | — |
| | portion | | | | | |
| | Cooling step (first half) | — | — | — | — | 320 |
| | Cooling step (second half) | — | — | — | — | 10 |
| Performance | Appearance | ◯ | ◯Δ | Δ | ⊙ | X |
| | Dimensional stability (MD) | −0.04 | −0.05 | −0.06 | −0.04 | −0.08 |
| | Dimensional stability (TD) | +0.04 | +0.04 | +0.05 | +0.03 | +0.06 |

### Example 4

A flexible laminate was produced as in Example 1 except that far infrared heaters were installed in the back of the slow-cooling roller. Five far infrared heaters were installed at intervals of 10 cm in the width direction. The actual temperatures of the laminate at the thermal lamination portion, the portion of contact with the slow-cooling roller, and the removal portion were measured. The cooling rates of the laminate were calculated from the differences in temperature between the individual temperature measurement positions and the times required for transferring the laminate between the individual temperature measurement positions. The results are shown in Table 1.

With respect to the resulting flexible laminate, appearance and dimensional stability (MD direction and TD direction) were evaluated by the methods which will be described below. The results are shown in Table 1.

### Comparative Example

A flexible laminate was produced as in Example 1 except that no slow-cooling roller was used. The actual temperatures of the laminate at the thermal lamination portion, the midpoint between the thermal lamination portion and the removal portion, and the removal portion were measured. The cooling rates of the laminate, in the cooling step (first half) and the cooling step (second half), were calculated from the differences in temperature between the individual temperature measurement positions and the times required for transferring the laminate between the individual temperature measurement positions. The results are shown in Table 1.

With respect to the resulting flexible laminate, appearance and dimensional stability (MD direction and TD direction) were evaluated by the methods which will be described below. The results are shown in Table 1.

<Performance Evaluation of Flexible Laminate>

(1) Appearance

The number of wrinkles generated per square meter in the surface of the flexible laminate was counted. The evaluation was conducted according to the following criteria:
⊙: No wrinkles
◯: One or less wrinkles per square meter
◯Δ: Two to three wrinkles per square meter
Δ: Four or more but less than six wrinkles per square meter
x: Six or more wrinkles per square meter
   (2) Dimensional Stability

The ratio of change in dimensions before and after the removal of the metal foils was measured and calculated as described below according to JIS C6481. That is, a 200 mm×200 mm square sample was cut out from each flexible laminate, and a hole with a diameter of 1 mm was formed in each of the four corners of a 150 mm×150 mm square in the sample. Two sides of each of the 200 mm×200 mm square sample and the 150 mm×150 mm square were directed in the MD direction and the other two sides were directed in the TD direction. These two squares were arranged so as to have a common center. The sample was left to stand in a thermo-hygrostatic chamber at 20° C. and 60% RH for 12 hours to condition humidity, and then the respective distances among the four holes were measured. Subsequently, the metal foils were removed from the flexible laminate by etching, and the sample was left to stand in a thermostatic chamber at 20° C. and 60% RH for 24 hours. The respective distances among the four holes were measured in the same manner as that before the etching. The ratio of change in dimensions was calculated according to the expression below, where D1 is an observed distance among the holes before removal of the metal foils, and D2 is an observed distance among the holes after removal of the metal foils. A smaller absolute value of the ratio of change in dimensions indicates higher dimensional stability.
Ratio of change in dimensions (%)={(D2−D1)/D1}×100

As shown in Table 1, in Comparative Example in which the slow cooling step of the present invention is not provided, the decreasing rate of the actual temperature of the laminate is large in the first half of the cooling step. The cooling rates between the individual temperature measurement positions in Examples 1 to 4 in which the slow cooling step is provided are smaller than the cooling rate in the first half of the cooling step in Comparative Example. In Examples 1 to 4, the cooling rates from the thermal lamination portion to the removal portion are relatively uniform.

As shown in Table 1, in Examples 1 to 4, occurrence of wrinkles is significantly suppressed as compared with Comparative Example. In particular, in Example 4 in which the heaters are provided besides the slow-cooling roller, excellent appearance is achieved.

Furthermore, with respect to dimensional stability in the MD direction and TD direction (orthogonal to the MD direction), Examples 1 to 4 show better results as compared with Comparative Example. In particular, Example 4 shows excellent dimensional stability.

The above-disclosed embodiments and examples are provided for the illustrative purpose only and do not limit the present invention. The present invention shall only be limited to the range defined in the following claims and includes any equivalent of the claims and modifications without departing from the spirit of the present invention.

### INDUSTRIAL APPLICABILITY

In accordance with the present invention, it is possible to produce flexible laminates having excellent appearance and dimensional stability. The present invention is preferably used to produce printed circuit boards for electronic and electrical devices, in particular, cellular phones.

1. A method for producing a flexible laminate comprising a heat-resistant adhesive film (A) and a metal foil (B) bonded to at least one surface of the heat-resistant adhesive film (A), the method comprising:
a step of performing thermal lamination by passing the heat-resistant adhesive film (A) and the metal foil (B) between at least one pair of metal rollers through a protective film;
a step of slowly cooling a laminate comprising the heat-resistant adhesive film (A), the metal foil (B), and the protective film; and
a step of separating the protective film.

2. The method for producing the flexible laminate according to claim 1, wherein the slow cooling step is performed by providing a heating mechanism of which temperature is set lower than the surface temperature of the metal rollers.

3. The method for producing the flexible laminate according to claim 2, wherein the heating mechanism comprises a slow-cooling roller.

4. The method for producing the flexible laminate according to claim 3, wherein the surface temperature of the slow-cooling roller is set lower than the surface temperature of the metal rollers by 50° C. to 250° C.

5. The method for producing the flexible laminate according to claim 3, wherein the surface temperature of the slow-cooling roller is set in a range of 150° C. to 350° C.

6. The method for producing the flexible laminate according to claim 1, wherein, in the slow cooling step, the cooling rate for the laminate is set in a range of 50° C./min to 300° C./min.

7. A method for producing a flexible laminate comprising a heat-resistant adhesive film (A) comprising one layer or two or more layers, one surface or both surfaces of the heat-resistant adhesive film (A) comprising a thermally fusible resin, and a metal foil (B) bonded to at least one surface of the heat-resistant adhesive film (A), the method comprising:
a step of performing thermal lamination by passing the heat-resistant adhesive film (A) and the metal foil (B) between at least one pair of metal rollers through a protective film;
a step of slowly cooling a laminate comprising the heat-resistant adhesive film (A), the metal foil (B), and the protective film at a cooling rate of 300° C./min or less until the surface temperature of the laminate is decreased to a temperature equal to or less than the glass transition temperature of the thermally fusible resin; and
a step of separating the protective film.

8. The method for producing the flexible laminate according to claim 7, wherein a slow-cooling roller of which temperature is set at the glass transition temperature of the thermally fusible resin is provided.

9. The method for producing the flexible laminate according to any one of claims 1 to 8, wherein the slow cooling step is performed by providing a plurality of heating mechanisms including a slow-cooling roller.
